(19) United States
(12) Patent Application Publication
(10) Pub. No.: US 2024/0051849 A1
(43) Pub. Date: Feb. 15, 2024

(54) METHOD FOR TREATING WATER

(71) Applicant: NEXCO TECHNOLOGY LIMITED, Kibworth Beauchamp, Leicester (GB)

(72) Inventors: Christopher Paul NEWMAN, Canterbury Kent (GB); Spencer Edwin TAYLOR, Camberley Surrey (GB); Nicholas James ROTH, Kibworth Leicestershire (GB); Roderick Clive GASKIN, Hempstead, Gillingham Kent (GB); Gayathri Devi ARIARATNAM, Hulland Ward, Ashbourne Derbyshire (GB)

(21) Appl. No.: 18/282,053

(22) PCT Filed: Mar. 16, 2022
(86) PCT No.: PCT/IB2022/052379

§ 371 Date: Sep. 14, 2023

(30) Foreign Application Priority Data
Apr. 23, 2021 (GB) 2105834.2

(51) Int. Cl. C02F 1/28; B01J 20/26; B01J 20/32

(52) U.S. Cl. CPC C02F 1/288; C02F 1/285; B01J 20/261; B01J 20/321; B01J 20/3255; C02F 2101/30

(57) ABSTRACT

A method of removing microplastic particles from a water-based liquid, comprising the exposure of the liquid to a solid surface on which is retained a sorbitan monooleate surfactant, in a concentration suitable for entrapping substantially all microplastic particles. The method is useful for removing microplastic particles and microfibres from fresh and saline natural waters, effluent water, such as grey water, storm water and waste waters from industrial processes, in addition to any kind of product based on water, such as mineral waters, milk, fruit juices, beverages, pharmaceutical and veterinary products.

### FIELD OF THE DISCLOSURE

This disclosure relates to a method for reducing the plastic (synthetic) microfibre content of microfibre-containing water.

### BACKGROUND TO THE DISCLOSURE

Synthetic fibres, as a partial or complete replacement of natural fibres, have become an accepted part of modern life. Examples of suitable fibre-forming materials have included polyamides (nylon), polyesters, various polyacrylics, polyurethanes and polyalkenes. These are typically produced by a melt spinning process, involving extrusion of the molten fibre material through a spinneret (a small nozzle), followed by spinning.

Recent concerns with the use of microplastics in commercial products and their enduring and potentially harmful presence in the environment has led to the realisation that synthetic fibres also contribute microparticles in the form of microfibres, ranging in size of from millimetres down to nanometres. These can result from the extrusion process itself, or from normal wear and tear or washing and drying. As a result, they have been found to constitute a large and increasing presence in terrestrial and aquatic environments. They are particularly problematic because they constitute a form of pollution that cannot be easily prevented by legislation, in that they are not a deliberate addition, but arise from the nature of the material itself, and will continue to exist, so long as artificial fibres are used. The problem and its magnitude is described, for example, in papers by Belzagui et al (Environmental pollution, Vol. 265, Part B (October 2020), 114889) and Mishra et al (Journal of Water Process Engineering, Vol. 38 (December 2020), 101612).

There have been attempts to reduce the generation of microfibres in the washing process. Some of these are described in papers by Mcllwraith et al, in Marine Pollution Bulletin, Volume 139, (February 2019), pp. 40-45 and Nappa et al (Science of The Total Environment, Volume 738, (10 Oct. 2020), 140412), in which various commercially-available products were tested for effectiveness. Some of these methods have been found to remove up to 78% of microfibres. However, these publications make it clear that the effectiveness of these products is limited, not only because of the indiscriminate nature of the materials captured, but more particularly, their inability to retain the more ecologically harmful smaller fibres.

### SUMMARY OF THE DISCLOSURE

It has now been found that there is a particularly effective way of removing substantially all microfibres from water, including the previously difficult smallest sizes. The method is also useful for the removal of other types of plastic microparticles from water. There is therefore provided a method of removing microplastic particles from a water-based liquid, comprising the exposure of the liquid to a solid surface on which is retained a non-ionic surfactant having an HLB value of 5 maximum in a concentration suitable for entrapping substantially all microplastic particles.

There is additionally provided a solid surface on which there is retained a non-ionic surfactant having an HLB value of 5 maximum in such proportion as to retain plastic microparticles.

### DETAILED DESCRIPTION OF THE DISCLOSURE

The use of the term “microplastic particles” refers to all small polymeric particles, that is, microparticles with a maximum dimension (measured in any dimension) of up to 5 mm and a minimum in the nanometre range, but they are more usually in the range of 1-100 microns, typically from 5-50 microns, and most usually 5-30 microns. They may be either added to products for specific purposes, or they may inadvertently be generated from products. Specific examples of the latter are microfibres, that is, microparticles that are elongated in one dimension, and which are often generated by the washing and use of artificial fibres. Another example is the microparticles that have been found in surprising quantity in liquids in plastic bottles, such as those used for bottled water and infant formula, and appearing to originate from the degeneration of the bottle material itself.

In a particular embodiment, the microparticles have a maximum aspect ratio (ratio of minimum dimension to maximum dimension) of 0.2. That is, the microparticles are elongate, which is typical of the microfibres shed by washed garments of synthetic material.

The use of the term “water-based liquid” encompasses not only fresh and saline natural waters, but also any kind of effluent water, such as grey water, storm water and waste waters from industrial processes, in addition to any kind of product based on water, such as mineral waters, milk, fruit juices, beverages, pharmaceutical and veterinary products.

Non-ionic surfactants with an HLB (hydrophile-lipophile balance) of 5 maximum are common items of commerce and are widely used to stabilise water-in-oil emulsions. Typical examples are those based on polyethylene oxide as hydrophile with a variety of possible lipophiles, such as nonyl phenol or water-insoluble polyalkylene oxides. A further group is the sorbitan monoesters, such as those available commercially under the name SPAN™.

It is surprising to find that these surfactants retained on a solid surface are capable of removing substantially all of the microplastics.

Further advantages of these surfactants are that many of them are biodegradable and will not persist in the environment after use, and that they can now comprise carbon atoms that do not originate from fossil fuels. Thus, the use of such materials benefits not only in their ability to remove one potential pollutant, but also that their manufacture and use is more sustainable. Additionally, some are available in food quality grades which can offer a wider scope of application.

The solid surface to which the surfactant can be any suitable solid surface that permits the attachment and retention of the surfactant. Typical examples include expanded polystyrene and polycaprolactone.

In a particular embodiment, the mixing of a surfactant with a low melting-point polymer such as polycaprolactone (melting point 60° C.) above the melting point provides, on cooling, a mouldable material capable of being formed into any desired shape. This surface retains the fibre-attracting properties of the surfactant, but in the form of a removable and replaceable unit.

Such a surface has an affinity for those microparticles presenting normal filtration challenges and those of greatest environmental longevity and threat. These include microparticles of, or containing, synthetic polymers, such as polyesters, polyacrylates, polyamides, for example nylons, polyurethanes, polyalkenes, for example, polypropylene and polyethylene, and PET (polyethylene terephthalate).

The abovementioned surfaces can be configured into suitable arrangements for different applications. For example, within the context of domestic laundering, it can be estimated that sufficient surface area for collection can be created from surface-treated structures, ranging from simple spheres, on the one hand, to complex structures that are able to be fabricated by techniques such as hot melt, extrusion or co-extrusion, pelleting, tabletting or 3D printing with CAD software.

In a further embodiment, the surfaces hereinabove described may be used on large bodies of water that suffer from microparticle pollution. Such as lakes, canals, estuaries and marine environments. For example, they may be incorporated into porous nets or membranes that may be stretched across a waterway, or as porous barriers surrounding delicate marine environments, such as reefs, or providers of seafood, such as oyster beds and fish farms. The barriers may themselves be surfaces as described, or suitable surfaces may be incorporated into them, for example, a net to which is attached porous containers of particulate surfaces, such as spheres or other shapes. There is therefore also provided a means of reducing microparticle pollution in large bodies of water, comprising the deployment therein of porous barriers comprising surfaces as hereinabove described.

In a further embodiment, the surface may be the solid surface of a liquid surface coating composition. The surfactant may be incorporated into the formulation, due allowance being made for the particular formulation (many such compositions already contain surfactants for various reasons, for example, the dispersal of pigments). In this embodiment, the surface can be renewed by, for example, washing down or simply recoating.

In a further embodiment, the surfaces hereinabove described may be used to augment conventional liquid/solid separation processes, a particular example being filtering processes. This has several potential beneficial effects. For example, many filtering processes rely on applying pressure or vacuum to force a liquid bearing suspended species through a filter. Removal of small particles requires the use of filters with small nominal pore sizes, and the pressure that may be needed to operate these filters will be higher than for a filter with a larger nominal pore size, and therefore the energy needed to be expended to make this work will be consequently higher.

The use of a surface as hereinabove described may remove the need for a filter with small nominal pore sizes, as much of the small particulate material will be attracted to and retained upon the surface itself. This would allow a reduction in the amount of energy that needs to be expended to achieve the required separation.

Some filtering processes may require the addition of bulk-phase chemicals to improve filtration efficiency, for example, to cause small microparticles to flocculate or coagulate into larger, more easily filterable particles. The use of a surface as hereinabove described may allow a reduction in, and even a complete removal of, such chemicals from a separation process.

The disclosure therefore also provides a filtration device, comprising at least two liquid/solid separation stages, at least one conventional liquid/solid separation means and at least one non-ionic surfactant-bearing surface as hereinabove described.

The disclosure additionally provides a method of filtering a microparticle-containing aqueous liquid, comprising at least two liquid/solid separation stages, at least one conventional filtration method, preceded by at least one liquid/solid separation stage comprising a non-ionic surfactant-bearing surface as hereinabove described.

In order for the surface to retain sufficient microplastic particles, it must have a suitable concentration of retained surfactant. This involves a suitable combination of surface area and surfactant quantity. Surface areas will naturally vary widely, depending on use and physical form, but the selection and preparation of suitable areas and concentrations falls within the ordinary skill of the art.

After use, it is an embodiment of the invention that the structures containing the collected particles may be removed from the application and disposed of as solid waste or recycled. Alternatively, depending on the type of surface, they can be regenerated for further use. This may be achieved, for example, by brushing the surface to remove the fibres.

In other uses, the inner surfaces of containers, such as plastic bottles, may be similarly treated, such that any microparticles contained therein, either as additives or generated by degradation of the bottle material, may be retained within the bottle. This treatment may be applied to the entire inner surface of the container, or only to a suitable area adjacent to the neck, spout or pouring orifice of the container, such that microparticles are retained as the bottle contents are poured.

The disclosure is further described with reference to the following examples, which exemplify specific embodiments, and which are not intended to be in any way limiting as to the scope of the disclosure.

### Example 1

This example demonstrates the collection of dispersed polymer microfibres from a laundering process.

The collecting support surface consisted of expanded polystyrene beads (nominally 10 mm diameter). These were individually treated for the purposes of demonstrating the invention by manually applying a thin coating of a surface-active agent using a fine paintbrush. The agents are shown in Table 1. The agents were applied as 50% solutions (w/w) in n-heptane, which was then allowed to evaporate.

TABLE 1

| Trade | | | Water solubility/ |
|---|---|---|---|
| name | Chemical name | HLB | miscibility |
| PPG | Polypropylene | 9.7 | Completely miscible |
| | glycol | | |
| SDBS | Sodium | 10.6 | Sparingly (0.8 g/L) |
| | dodecylbenzene | | |
| | sulfonate | | |
| Aerosol ™ | Dioctyl sodium | 10 | Soluble (8.2 g/L) |
| OT | sulfosuccinate | | |
| SPAN ™ | Sorbitan | 4.3 | 0.02 mg/L (estimated |
| 80 | monooleate | | by EPI Suite*) |
| SPAN ™ | Sorbitan | 1.0 | NDA (no data |
| 85 | trioleate | | available) |
| SPAN ™ | Sorbitan | 4.7 | 0.012 mg/L (estimated |
| 60 | monostearate | | by EPI Suite) |
| SPAN ™ | Sorbitan | 2.1 | NDA |
| 65 | tristearate | | |
| SPAN ™ | Sorbitan | 8.6 | 13 mg/L (est. EPI |
| 20 | monolaurate | | Suite) |

*EPI (Estimations Program Interface) Suite ™ is a software suite developed by the US Environmental Protection Agency and Syracuse Research Corp. It allows the estimation of various physical and chemical properties.

For the tests, suspensions of polyester microfibres were separately produced from small (3 cm×3 cm) swatches of commercial undyed fleece material by rolling and tumbling in 30 mL deionised water for typically 1 hour, after which the fleece swatches were removed.

Each of the treated samples of polystyrene beads was added to a suspension sample as prepared above, and gently agitated for 10 minutes.

The beads were removed and examined under UV light. The suspension samples from which they were removed were also examined and compared with an untreated sample. The results are shown in Table 2 below.

TABLE 2

| Trade | | Fibres on | Fibres remaining |
|---|---|---|---|
| name | Chemical name | beads | in suspension |
| PPG | Polypropylene | none | Unchanged from |
| | glycol | | original suspension |
| SDBS | Sodium | none | Unchanged from |
| | dodecylbenzene | | original suspension |
| | sulfonate | | |
| Aerosol ™ | Dioctyl sodium | none | Unchanged from |
| OT | sulfosuccinate | | original suspension |
| SPAN ™ 80 | Sorbitan | Substantial | Considerably reduced |
| | monooleate | number | |
| SPAN ™ 85 | Sorbitan | none | Unchanged from |
| | trioleate | | original suspension |
| SPAN ™ 60 | Sorbitan | none | Unchanged from |
| | monostearate | | original suspension |
| SPAN ™ 65 | Sorbitan | none | Unchanged from |
| | tristearate | | original suspension |
| SPAN ™ 20 | Sorbitan | none | Unchanged from |
| | monolaurate | | original suspension |

In a further test, polystyrene balls were half-coated, i.e., only one hemisphere of the balls was coated (the moulding line of the balls was used as the boundary for the two hemispheres, and the uncoated hemisphere was distinguished by an indentation) and the balls subjected to the same procedure. Examination showed that the coated hemispheres held fibres, while the uncoated hemispheres were almost completely microfibre-free.

### Example 2

This example shows the treatment and removal of microplastic fibres from different water mixtures (deionised water, saline, laundry detergent and fabric conditioner).

Surface preparation: 20 mm polystyrene balls were coated with neat (undiluted as commercially sold) SPAN™ 80 at room temperature over 50% of their surface. As in Example 1, the moulding line on the balls was used as the marker for coating. The uncoated half of the ball was marked with an indentation.

Fibre suspension preparation: New polyester polar fleece fabric was processed with a hand-held blender in deionised water. Red fabric was used in order to assess fibre attachment to the polystyrene balls in visible light. The bottle containing the fibre suspension was placed in a water bath at 25 degrees C.

Test Method: All tests were carried out in 50 ml plastic centrifuge tubes. In order to test in the presence of salt, laundry detergent and laundry fabric conditioner, these materials were weighed into the centrifuge tubes to produce the desired material concentrations on addition of 25 ml of the fibre suspension in deionised water. On addition of the fibre suspension, all tubes were gently agitated until the added materials were dissolved.

Two of the SPAN™™ 80 half-surface coated polystyrene balls were added to each tube and gently agitated for one minute to ensure total surface coverage. The balls were then removed and inspected for fibre attachment.

Water Mixtures.
(a) deionised water at 25° C.;
(b) deionised water containing kitchen sea salt to give a concentration of 30000 ppm an approximation to seawater;
(c) deionised water with the addition of Ariel™ gel cold wash colour formulation to give a typical working concentration of around 0.6% w/v;
(d) deionised water with the addition of Comfort Intense™ fabric conditioner to give a typical working concentration of 0.75 w/v %.

Visual inspection of the polystyrene balls shows fibres attached to the coated half of the ball surface and none on uncoated surface in all samples as shown in Table 3.

TABLE 3

| Water type | Treated surface | Untreated Surface |
|---|---|---|
| a) deionised | Fibres attracted and | No fibres on surface |
| | retained on surface | |
| b) with salt (saline) | Fibres attracted and | No fibres on surface |
| | retained on surface | |
| c) with detergent | Fibres attracted and | No fibres on surface |
| | retained on surface | |
| d) with fabric conditioner | Fibres attracted and | No fibres on surface |
| | retained on surface | |

### Example 3

This exemplifies the pre-treatment of the surfaces prior to SPAN™ 80 application.

The examples in Example 2 (a) and (c) were repeated, with the exception that the polystyrene balls were pre-treated by holding in a jet of steam from a domestic steam cleaner for 30 seconds prior to coating with SPAN™ 80.

On application of the SPAN™ 80 to the hemispheres of the polystyrene balls, it was noticeable that the SPAN™ 80 was interacting with the polystyrene surface to produce a viscous milky layer. The treated polystyrene balls were left overnight before use. After this resting period the treated surface of the polystyrene balls was no longer sticky to the touch.

Microfibre solutions prepared as described in Example 1 were then exposed to these treated balls (2 per tube) at 25° C.

Visual inspection of the polystyrene balls shows fibres attached to the coated half of the ball surface and none on uncoated surface in all samples as shown in Table 4.

TABLE 4

| Water type | Treated surface | Untreated Surface |
|---|---|---|
| a) deionised water | Fibres attracted and | No fibres on surface |
| | retained on surface | |
| b) with detergent | Fibres attracted and | No fibres on surface |
| | retained on surface | |

Further Observations.

Inspection of the container from the test carried out with laundry detergent shows that the remaining microfibres are aggregated and resting at the bottom of the container.

### Example 4

This example describes the use of an alternative support substrate.

The support surface in this case was a mouldable polycaprolactone (a commercial product called ESUN Polymorph™ was used).

Surface preparation.

A small quantity (approx 1.5 g) of the polycaprolactone was melted in an oven at a measured temperature of 100 degrees C. Two drops of SPAN™ 80 liquid were added to the melted polymer and mixed. The sample was returned to the oven for a few minutes and then remixed. The mixture was allowed to cool and solidify. The solid material was removed from its container and trimmed to produce an approximately circular test piece. A similar piece of polycaprolactone was produced without the addition of SPAN™™ 80.

Fibre suspension preparation.

New polyester polar fleece fabric was processed with a hand-held blender in deionised water. Red fabric was used in order to assess fibre attachment to the test pieces in visible light. The bottle containing the fibre suspension was placed in a water bath at 25 degrees C.

Test Method.

All tests were carried out in 50 ml plastic centrifuge tubes.

The test pieces were added to separate tubes and gently agitated for one minute to ensure total surface coverage. The test pieces were then removed and inspected for fibre attachment.

The results are shown in the accompanying figures, where

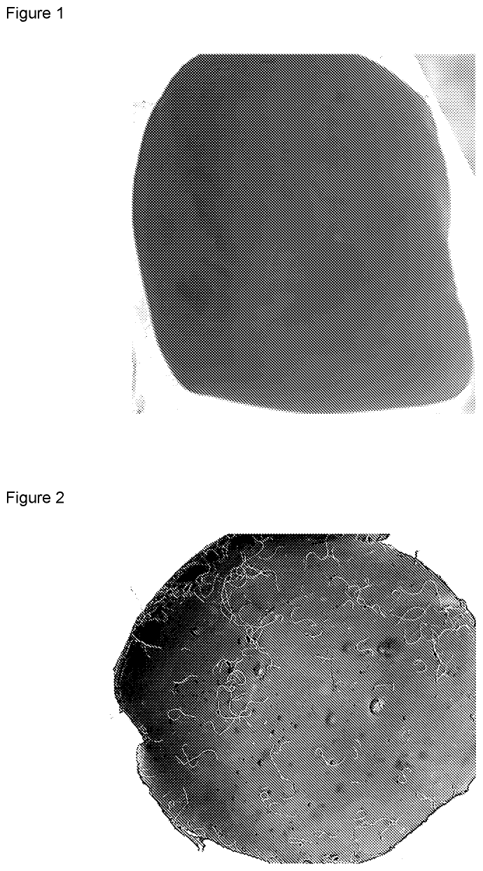

FIG. 1 shows a negative image of the polycaprolactone without the addition of SPAN™ 80 (the negative image permits better visibility).

FIG. 2 shows a negative image of the polycaprolactone with the addition of SPAN™ 80.

It can clearly be seen that the treated polycaprolactone picks up microfibres, whereas the untreated polycaprolactone does not.

1. A method of removing microplastic particles from a water-based liquid, comprising exposing the liquid to a solid surface on which is retained sorbitan monooleate surfactant, in a concentration suitable for entrapping substantially all microplastic particles.

2. The method according to claim 1, in which the microparticles have a maximum dimension of 5 mm.

3. The method according to claim 2, in which the microparticles have a size range of 1-100 microns.

4. The method according to claim 2, in which the microparticles have an aspect ratio of 0.2 maximum.

5. The method according to claim 1, in which the microparticles at least partially comprise synthetic organic polymer.

6. The method according to claim 3, in which the microparticles are completely synthetic organic polymer.

7. The method according to claim 4, in which the polymer is selected from the group consisting of polyester, acrylic, polyalkylene, polyamide, polyurethane, PET, and combinations thereof.

8. The method according to claim 1, in which the microplastic particles are microfibres.

9. (canceled)

10. (canceled)

11. A solid surface that is adapted to be immersed in a microplastic particle-containing liquid and which is adapted to retain on said surface substantially all microplastic particles present, there being retained on the surface sorbitan monooleate surfactant in a concentration adapted to retain the microplastic particles.

12. The solid surface according to claim 11, which surface is a synthetic polymer.

13. A filtration device, comprising at least two liquid/solid separation stages, at least one conventional liquid/solid separation stage and at least one surfactant-bearing surface according to claim 11.

14. A method of filtering a microparticle-containing aqueous liquid, comprising at least two liquid/solid separation stages, at least one conventional liquid/solid separation stage, preceded by at least one stage comprising a surfactant-bearing surface according to claim 11.

15. A method of reducing microparticle pollution in large bodies of water, comprising the deployment therein of porous barriers comprising surfaces according to claim 11.

16. The method according to claim 3, in which the microparticles have a size range of microns.

17. The method according to claim 3, in which the microparticles have a size range of microns.
